(19) United States
(12) Patent Application Publication
(10) Pub. No.: US 2018/0175413 A1
(43) Pub. Date: Jun. 21, 2018

(54) CELL FRAME FOR FUEL CELL

(71) Applicants: HYUNDAI MOTOR COMPANY, Seoul (KR); KIA MOTORS CORPORATION, Seoul (KR)

(72) Inventors: Yil Hoon Yi, Busan (KR); Byeong-Heon Jeong, Yongin-si (KR); Seong Il Heo, Yongin-si (KR)

(21) Appl. No.: 15/819,698

(22) Filed: Nov. 21, 2017

(30) Foreign Application Priority Data
Dec. 16, 2016 (KR) 10-2016-0172807

(51) Int. Cl. H01M 8/04119; H01M 8/1018; H01M 8/026; H01M 8/0273

(52) U.S. Cl. CPC H01M 8/04179; H01M 8/1018; H01M 2008/1095; H01M 8/0273; H01M 8/026

(57) ABSTRACT

A cell frame for a fuel cell includes a flat part provided in a reaction gas inlet and outlet port; an expansion groove provided at a location between a reaction gas hole and the reaction zone by a portion of the flat part being depressed downward; and a raised part provided by protruding upward from an inner bottom surface of the expansion groove, and configured to extend in a flow direction of reaction gas.

### CROSS REFERENCE TO RELATED APPLICATION

The present application claims priority to Korean Patent Application No. 10-2016-0172807, filed Dec. 16, 2016, the entire contents of which is incorporated herein for all purposes by this reference.

### BACKGROUND OF THE INVENTION

### Field of the Invention

The present invention relates to a cell frame for a fuel cell, which is capable of increasing a reaction gas flow in an inlet and outlet port in a cell frame integrated with a membrane electrode assembly (MEA) and a gas diffusion layer (GDL), to alleviate clogging of a passage due to condensate or generated water, whereby it is possible to improve stack operational stability and operational efficiency.

### Description of the Related Art

Generally, a fuel cell refers to an electricity generator that directly converts chemical reaction energy of hydrogen and oxygen into electrical energy. Particularly, a polymer electrolyte membrane fuel cell has high power density, high efficiency, and low operating temperature, so it is applied to many fields, such as vehicles, buildings, and the like. Further, since only water is produced as a reaction product, the fuel cell is considered to be very promising as environmentally friendly alternative energy.

Chemical energy generated by the fuel cell is the result of an electrochemical reaction, which is reverse reaction of water electrolysis. The oxidation reaction of hydrogen at the anode and the reduction reaction of oxygen at the air electrode proceed to generate electricity and produce water. Therefore, how to manage the produced water is a major issue concerning fuel cells. A unit cell of fuel cell is constituted by a membrane electrode assembly (MEA), a gas diffusion layer (GDL), a gasket, a separation plate, and the like. Water is produced in the membrane electrode assembly (MEA), and the water flows along a passage of the separation plate and is discharged through an outlet port of the anode/cathode outside the cell. Here, when the water clogs the outlet for reaction gas, flowability of reaction gas is reduced, whereby operational stability of fuel cell stack is lowered.

Conventionally, when reaction-generated water of fuel cell and condensate of humidified gas are increased, they are likely to be condensed or clogged in a reaction gas inlet and outlet port which results in the reaction gas flow becoming poor, whereby operational stability of fuel cell stack may be lowered. Accordingly, in the manifold of a cell frame, a structure for improving flowability of reaction gas and reaction generated water is required.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose a cell frame for a fuel cell, which is capable of increasing a reaction gas flow in an inlet and outlet port in a cell frame integrated with a membrane electrode assembly (MEA) and a gas diffusion layer (GDL), to alleviate clogging of a passage due to condensate or generated water, whereby it is possible to improve stack operational stability and operational efficiency.

In order to achieve the above object, according to one aspect of the present invention, there is provided a cell frame for a fuel cell, as a frame that is injection-molded on an edge of a reaction zone including a membrane electrode assembly (MEA), the cell frame including: a flat part provided in a reaction gas inlet and outlet port; an expansion groove provided at a location between a reaction gas hole and the reaction zone by a portion of the flat part being depressed downward; and a raised part provided by protruding upward from an inner bottom surface of the expansion groove, and configured to extend in a flow direction of reaction gas.

The raised part may be provided in plural and is disposed inside the expansion groove, and the raised parts are spaced apart from each other.

The inner bottom surface of the expansion groove may be disposed lower than the flat part, and an outer bottom surface opposite to the inner bottom surface provided with the raised part may be in contact with a lower separation plate.

A top portion of the raised part may be disposed higher than the flat part, and may be in contact with an upper separation plate.

The raised part may extend between a front end and a rear end of the expansion groove so as to connect the front end with the rear end of the expansion groove along the flow direction of reaction gas.

A rear end of the expansion groove disposed close to the reaction zone may be spaced apart from a rear end of the raised part, with a rear space being provided therebetween.

The raised part may be provided in plural and may be disposed inside the expansion groove, and the raised parts may be spaced apart from each other, whereby the rear spaces provided between the rear ends of the raised parts and the rear end of the expansion groove may communicate with each other.

A front end of the expansion groove disposed close to the reaction gas hole may be spaced apart from a front end of the raised part, with a front space being provided therebetween.

A rear end of the expansion groove disposed close to the reaction zone may be spaced apart from a rear end of the raised part, with a rear space being provided therebetween, and a front end of the expansion groove disposed close to the reaction gas hole may be spaced apart from a front end of the raised part, with a front space being provided therebetween.

The raised part may be provided in plural and may be disposed inside the expansion groove, and the raised parts may be spaced apart from each other, whereby the front spaces and the rear spaces provided respectively in front and rear of the raised parts may communicate with each other in respective lateral directions.

A gasket may be provided at a location opposite to the raised part based on a lower separation plate, and a length of the raised part may be a same as or longer than a length of the gasket. Also, the raised part of the frame may overlap the gasket.

The gasket may be disposed at a location between the front and rear ends of the raised part, and may be supported by the raised part.

A diffusion part may be provided at a location between the expansion groove and the reaction zone, with a plurality of channels being provided by protruding or by being depressed on the diffusion part along the flow direction of reaction gas.

The reaction zone of the fuel cell may be configured such that the membrane electrode assembly (MEA) and a gas diffusion layer (GDL) are integrally coupled to each other.

According to the cell frame for a fuel cell of the present invention, in a cell frame structure having a reaction gas inlet and outlet port passage (groove), flowability of reaction gas and generated water is improved, whereby it is possible to improve operational stability of fuel cell stack.

It is further advantageous in that pressure differential (decrease in parasitic loss) of the reaction gas inlet and outlet port is reduced, so output of fuel cell stack is improved.

It is further advantageous in that channels are formed on the diffusion part of the frame, whereby it is possible to further improve dispensability and reduce pressure differential. At the same time, in the separation plate, it is possible to remove the channels, whereby it is advantageous for forming the separation plate, and reducing cost.

It is further advantageous in that structural stability of fuel cell stack is improved because a springback phenomenon is less than in the case of forming channels on the separation plate.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1 to 3 are views showing a cell frame for a fuel cell according to a first embodiment of the present invention;

FIGS. 4 to 7 are views showing a cell frame for a fuel cell according to a second embodiment of the present invention;

FIGS. 8 to 10 are views showing a cell frame for a fuel cell according to a third embodiment of the present invention; and

FIG. 11 is a view showing a cell frame for a fuel cell according to a fourth embodiment of the present invention.

### DETAILED DESCRIPTION OF THE INVENTION

Hereinbelow, exemplary embodiments of the present invention will be described in detail with reference to the accompanying drawings. Throughout the drawings, the same reference numerals will refer to the same or like parts.

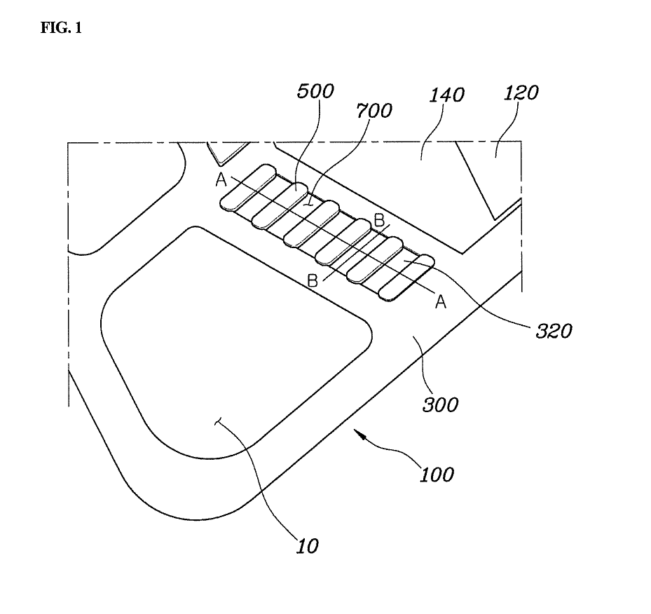

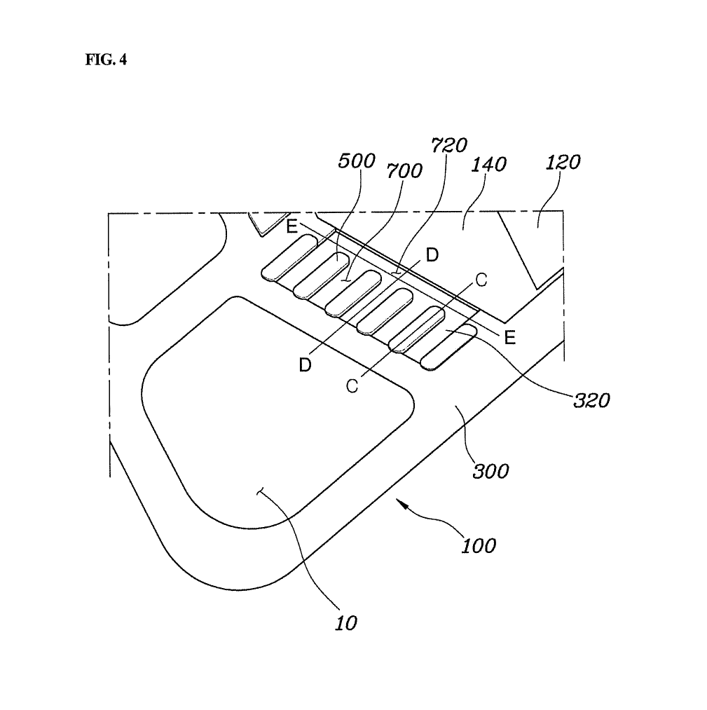

FIGS. 1 to 3 are views showing a cell frame for a fuel cell according to a first embodiment of the present invention; FIGS. 4 to 7 are views showing a cell frame for a fuel cell according to a second embodiment of the present invention; FIGS. 8 to 10 are views showing a cell frame for a fuel cell according to a third embodiment of the present invention; and FIG. 11 is a view showing a cell frame for a fuel cell according to a fourth embodiment of the present invention.

FIGS. 1 to 3 are views showing a cell frame for a fuel cell according to the first embodiment of the present invention, and the cell frame for a fuel cell according to the present invention, as a frame that is injection-molded on an edge of a reaction zone 120 configured such that a membrane electrode assembly (MEA) and a gas diffusion layer (GDL) are integrally coupled to each other, the cell frame includes: a flat part 300 provided in a reaction gas inlet and outlet port 100; an expansion groove 320 provided at a location between a reaction gas hole 10 and the reaction zone 120 by a portion of the flat part 300 being depressed downward; and a raised part 500 provided by protruding upward from an inner bottom surface of the expansion groove 320, is and configured to extend in a flow direction of reaction gas. The reaction zone 120 may be constituted by only the membrane electrode assembly (MEA), or may be configured such that the gas diffusion layer (GDL) is integrally coupled to the membrane electrode assembly (MEA).

FIG. 1 is a plan view showing a manifold of the cell frame of the present invention, wherein the present invention is a cell frame structure having channels Y of the reaction gas inlet and outlet port 100. The present invention is configured such that the membrane electrode assembly (MEA) and the gas diffusion layer (GDL) are layered to be integrated with each other, so as to form the reaction zone 120, and then a frame is insert-molded on the edge of the reaction zone by injection.

Accordingly, the frame includes: the flat part 300 provided along the edge of the reaction zone 120; and the reaction gas hole 10 provided at an end of the flat part 300 to allow reaction gas to flow, as shown in the drawing. The expansion groove 320 is provided at a location between the reaction gas hole 10 and the reaction zone 120 by a portion of the flat part 300 being depressed downward; and the raised part 500 is provided by protruding upward from the inner bottom surface of the expansion groove 320, and is configured to extend in a flow direction of reaction gas so as to guide the reaction gas flow.

In other words, the present invention is configured such that the frame is depressed to form a reaction gas passage 700 or a groove between the raised parts 500 in a direction opposite to a surface where gas flows, in order to facilitate reaction gas flow or reaction generated water discharge.

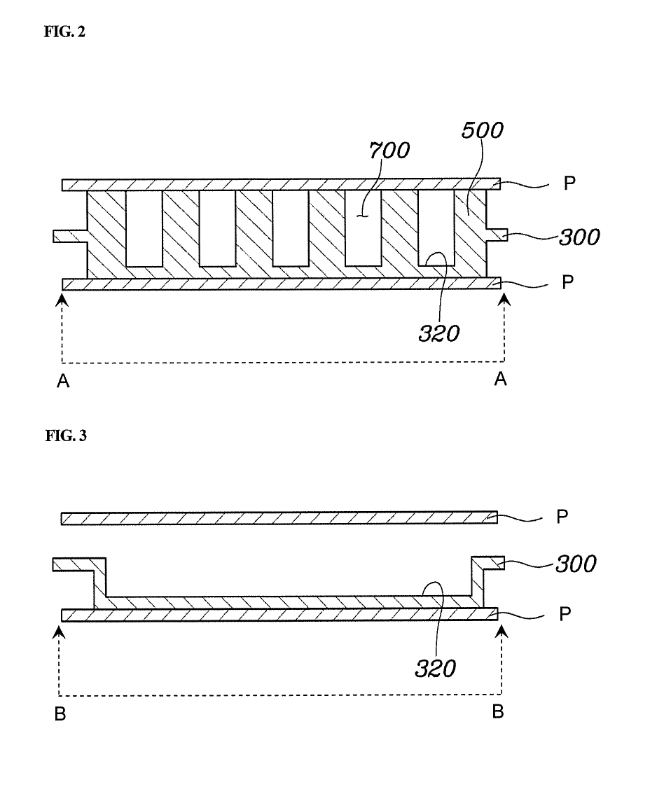

FIG. 2 is a sectional view taken along line A-A of FIG. 1; and FIG. 3 is a sectional view taken along line B-B of FIG. 1. Based on the frame, separation plates P in e.g. FIGS. 2 and 3 are respectively coupled to lower and upper surfaces thereof. According to the present invention, the reaction gas passage 700 is formed between the raised parts 500, whereby a depth of the reaction gas passage 700 is further deep.

To be more specific, the raised part 500 may be provided in plural and may be disposed inside the expansion groove 320, and the raised parts 500 may be spaced apart from each other. Further, the reaction gas passage 700 is formed between gaps of the raised parts 500. Meanwhile, the inner bottom surface of the expansion groove 320 may be disposed lower than the flat part 300, and an outer bottom surface opposite to the inner bottom surface provided with the raised part 500 may be in contact with a lower separation plate P. Further, a top portion of the raised part 500 may be disposed higher than the flat part 300, and may be in contact with an upper separation plate P. Thereby, it is possible to securely support and maintain the reaction gas passage 700. Further, the raised part 500 may extend between a hunt end and a rear end of the expansion groove 320 so as to connect the front end with the rear end of the expansion groove 320 along the flow direction of reaction gas.

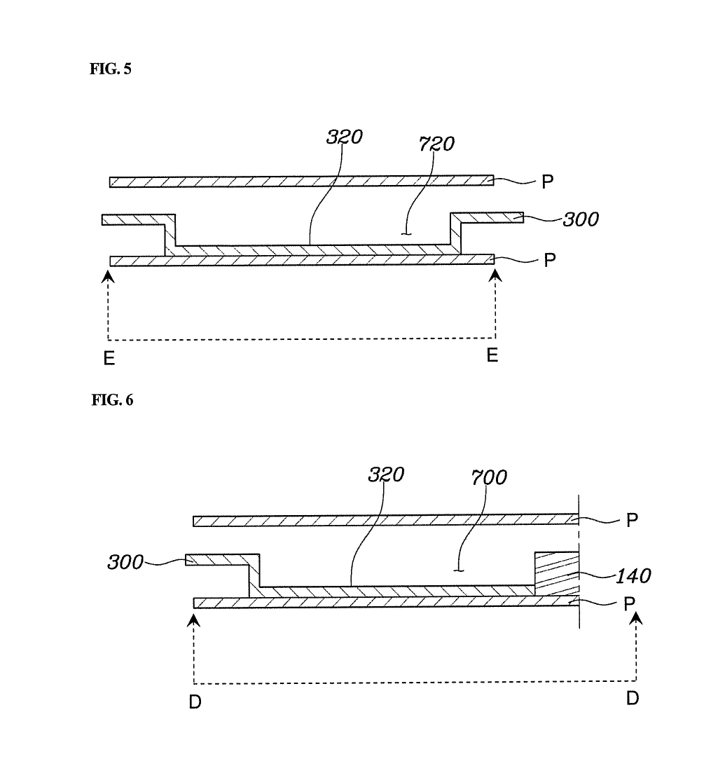

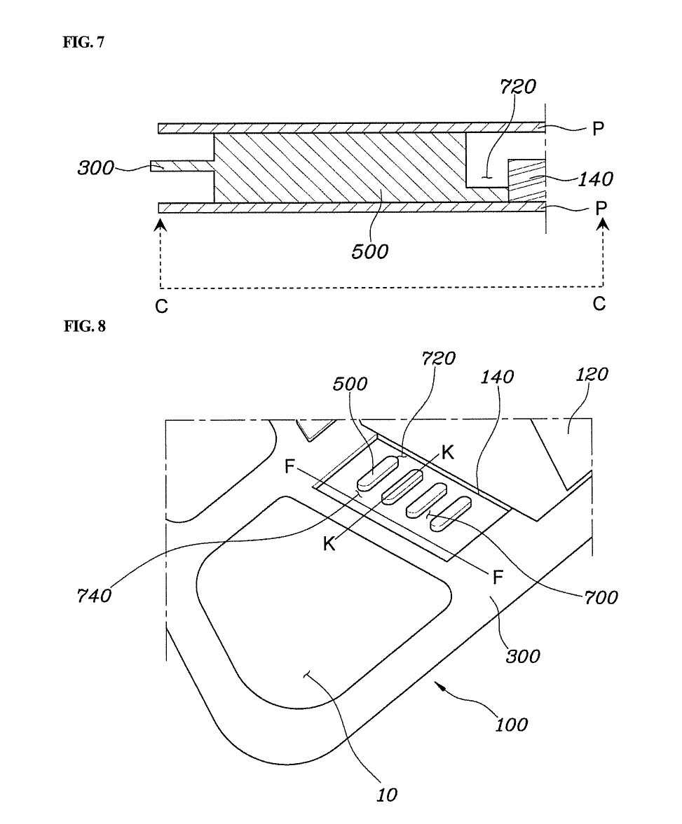

FIGS. 4 to 7 are views showing a cell frame for a fuel cell according to a second embodiment of the present invention. FIG. 5 shows a sectional view taken along line E-E of FIG. 4; FIG. 6 shows a sectional view taken along line D-D of FIG. 4; and FIG. 7 shows a sectional view taken along line C-C of FIG. 4. In this case, a rear end of the expansion groove 320 disposed close to the reaction zone 120 is spaced apart from a rear end of the raised part 500 so as to form a rear space 720 therebetween. Further, the raised part 500 may be provided in plural and may be disposed inside the expansion groove 320, and the raised parts 500 may be spaced apart from each other, whereby the rear spaces 720 provided between the rear ends of the raised parts 500 and the rear end of the expansion groove 320 may communicate with each other.

Particularly, in this case, the rear end of the expansion groove 320 is in direct contact with the diffusion part 140, whereby it is possible to further improve flowability of reaction gas. According to this structure, the reaction gas passage 700 is formed as a gap between the raised parts 500, so dispensability and flowability of reaction generated water and reaction gas are improved. Further, pressure differential of the reaction gas inlet and outlet port 100 is reduced, so output of fuel cell stack is improved.

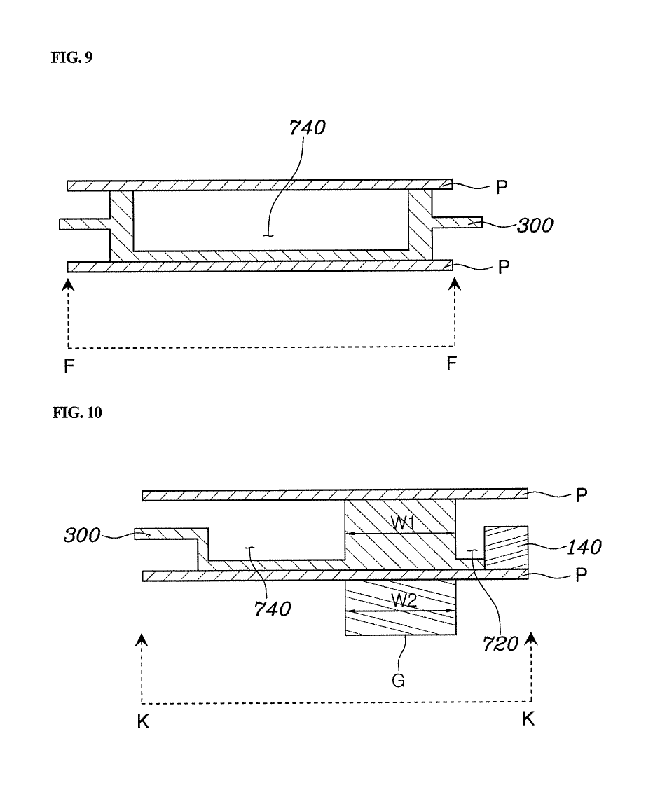

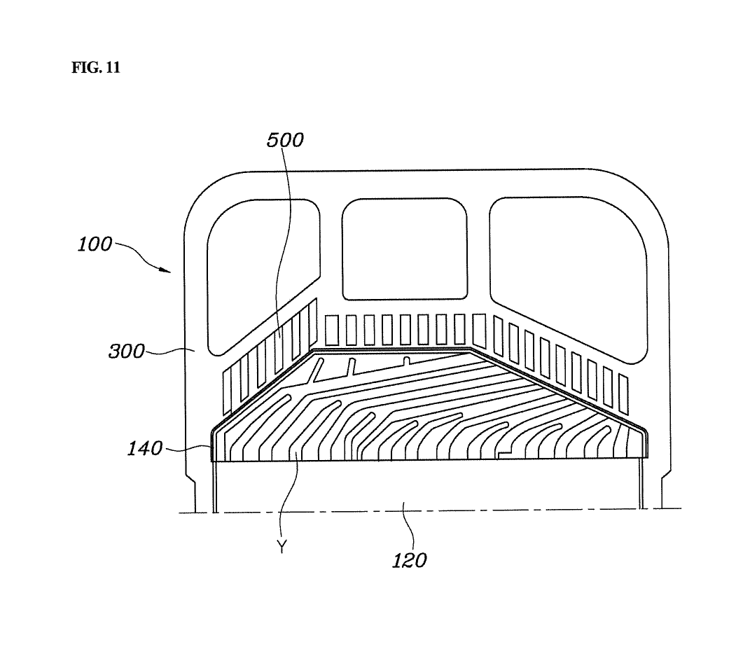

FIGS. 8 to 10 are views showing a cell frame for a fuel cell according to a third embodiment of the present invention. FIG. 9 shows a sectional view taken along line F-F of FIG. 8; and FIG. 10 is a sectional view taken along line K-K of FIG. 8. In this case, a rear end of the expansion groove 320 disposed close to the reaction zone 120 may be spaced apart from a rear end of the raised part 500 to form a rear space 720 therebetween; and a front end of the expansion groove 320 disposed close to the reaction gas hole 10 may be spaced apart from a front end of the raised part 500 to form a front space 740 therebetween. In other words, spaces are formed in front and rear of the raised part 500. Further, the raised part 500 may be provided in plural and may be disposed inside the expansion groove 320, and the raised parts 500 may be spaced apart from each other, whereby the front spaces 740 and the rear spaces 720 provided respectively in front and rear of the raised parts 500 may communicate with each other in respective lateral directions.

In this case, in order to improve flowability of reaction gas and reaction-generated water in the frame, a size of the raised part 500 is reduced to secure a space for the reaction gas passage 700. Further, the reaction gas passage 700 is configured to be expanded by reducing a length of the raised part 500. Here, a line length W1 of the raised part 500 of the frame should be the same as or longer than an airtight line length W2 of the gasket G provided on a cooling surface of the separation plate P. In other words, the gasket G may be provided at a location opposite to the raised part 500 based on a lower separation plate P, and a length of the raised part 500 may be the same as or longer than a length of the gasket G. Thereby, the gasket G is disposed at a location between the front and rear ends of the raised part 500, and may be supported by the raised part 500. Also, the gasket may exactly overlap the raised part.

Meanwhile, FIG. 11 is a view showing a cell frame for a fuel cell according to a fourth embodiment of the present invention. In this case, a diffusion part 140 may be provided at a location between the expansion groove 320 and the reaction zone 120, with a plurality of channels Y being provided by protruding or by being depressed on the diffusion part 140 along the flow direction of reaction gas. To be more specific, in order to improve flowability of reaction gas and reaction generated water in the frame, the channels Y are injection-molded on the diffusion part 140. In this case, it is possible to realize a more precise shape of the reaction gas passage 700 than the case of molding the channels Y on the metal separation plate P, whereby it is possible to improve flowability of reaction gas and reaction-generated water, and pressure differential of the reaction gas inlet and outlet port 100 is reduced, so output of fuel cell stack is improved. Also, the diffusion part contacts a bottom portion of the cell frame having the flat part. The bottom portion contacting the flat part does not have a vertical portion and a horizontal portion above the bottom portion. In this way, the cell frame having the bottom portion contacting the diffusion part is not symmetrical.

Further, it is possible to further improve dispensability and reduce pressure differential by forming the channels Y on the diffusion part 140 of the frame. At the same time, in the separation plate P, it is possible to remove the channels Y, whereby it is advantageous for forming the separation plate P, and reducing cost. Further, in this frame structure, structural stability of fuel cell stack is improved because a springback phenomenon caused by steel forming is less than the case of forming channels Y on the separation plate P.

According to the cell frame for a fuel cell of the present invention, in a cell frame structure having the reaction gas inlet and outlet port passage 700 (groove), flowability of reaction gas and generated water is improved, whereby it is possible to improve operational stability of fuel cell stack.

Pressure differential (decrease in parasitic loss) of the reaction gas inlet and outlet port 100 is reduced, so output of fuel cell stack is improved.

It is possible to further improve dispensability and reduce pressure differential by forming the channels Y on the diffusion part 140 of the frame. At the same time, in the separation plate P, it is possible to remove the channels Y, whereby it is advantageous for forming the separation plate P, and reducing cost.

In this frame structure, structural stability of a fuel cell stack is improved because a springback phenomenon caused by steel forming is less than the case of forming channels Y on the separation plate P.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A cell frame for a fuel cell, as a frame that is injection-molded on an edge of a reaction zone including a membrane electrode assembly (MEA), the cell frame comprising:
a flat part provided in a reaction gas inlet and outlet port;
an expansion groove provided at a location between a reaction gas hole and the reaction zone by a portion of the flat part being depressed downward; and
a raised part provided by protruding upward from an inner bottom surface of the expansion groove, and configured to extend in a flow direction of reaction gas.

2. The cell frame of claim 1, wherein
the raised part is provided in plural and is disposed inside the expansion groove, and the raised parts are spaced apart from each other.

3. The cell frame of claim 1, wherein
the inner bottom surface of the expansion groove is disposed lower than the flat part, and an outer bottom surface opposite to the inner bottom surface provided with the raised part is in contact with a lower separation plate.

4. The cell frame of claim 1, wherein
a top portion of the raised part is disposed higher than the flat part, and is in contact with an upper separation plate.

5. The cell frame of claim 1, wherein
the raised part extends between a front end and a rear end of the expansion groove so as to connect the front end with the rear end of the expansion groove along the flow direction of reaction gas.

6. The cell frame of claim 1, wherein
a rear end of the expansion groove disposed close to the reaction zone is spaced apart from a rear end of the raised part, with a rear space being provided therebetween.

7. The cell frame of claim 6, wherein
the raised part is provided in plural and is disposed inside the expansion groove, and the raised parts are spaced apart from each other, whereby the rear spaces provided between the rear ends of the raised parts and the rear end of the expansion groove communicate with each other.

8. The cell frame of claim 1, wherein
a front end of the expansion groove disposed close to the reaction gas hole is spaced apart from a front end of the raised part, with a front space being provided therebetween.

9. The cell frame of claim 1, wherein
a rear end of the expansion groove disposed close to the reaction zone is spaced apart from a rear end of the raised part, with a rear space being provided therebetween, and a front end of the expansion groove disposed close to the reaction gas hole is spaced apart from a front end of the raised part, with a front space being provided therebetween.

10. The frame of claim 9, wherein
the raised part is provided in plural and is disposed inside the expansion groove, and the raised parts are spaced apart from each other, whereby the front spaces and the rear spaces provided respectively in front and rear of the raised parts communicate with each other in respective lateral directions.

11. The frame of claim 9, wherein
a gasket is provided at a location opposite to the raised part based on a lower separation plate, and a length of the raised part is a same as or longer than a length of the gasket.

12. The frame of claim 11, wherein
the gasket is disposed at a location between the front and rear ends of the raised part, and is supported by the raised part.

13. The cell frame of claim 1, wherein
a diffusion part is provided at a location between the expansion groove and the reaction zone, with a plurality of channels being provided by protruding or by being depressed on the diffusion part along the flow direction of reaction gas.

14. The cell frame of claim 1, wherein
the reaction zone of the fuel cell is configured such that the membrane electrode assembly (MEA) and a gas diffusion layer (GDL) are integrally coupled to each other.

15. The cell frame of claim 13, wherein the diffusion part contacts a bottom portion of the cell frame having the flat part.

16. The cell frame of claim 15, wherein the bottom portion contacting the diffusion part does not have a vertical portion.

17. The cell frame of claim 15, wherein the bottom portion contacting the diffusion part does not have a horizontal portion above the bottom portion.

18. The cell frame of claim 16, wherein the cell frame having the bottom portion contacting the diffusion part is not symmetrical.

19. The cell frame of claim 17, wherein the cell frame having the bottom portion contacting the diffusion part is not symmetrical.

20. The cell frame of claim 11, wherein the gasket exactly overlaps the raised part.
